(19) United States
(12) Patent Application Publication
(10) Pub. No.: US 2002/0186524 A1
(43) Pub. Date: Dec. 12, 2002

(54) Electric meter box heat shield

(76) Inventor: Patrick F. Detchman, Fullerton, CA (US)

Correspondence Address: PATRICK F. DETCHMAN, 9757 HOUSTON AVE., FULLERTON, CA, 92833, US

(21) Appl. No.: 09/811,258

(22) Filed: Jun. 11, 2001

(51) Int. Cl. H02B 1/00

(52) U.S. Cl. 361/659; 73/855; 324/156

(57) ABSTRACT

“ELECTRIC METER BOX HEAT SHIELD” This simple new way to protect and improve the preformance, extend the usful life of an existing electrical meter box. Consumers can install with out any electrical training. It gives consumers a wepon to help fight high electric costs and costly repairs when installed on a meter box that is in normal operating condition. simply slip the shield oved the meter glass to provide shade on the enclosure there by reducing tempture of the enclosure.

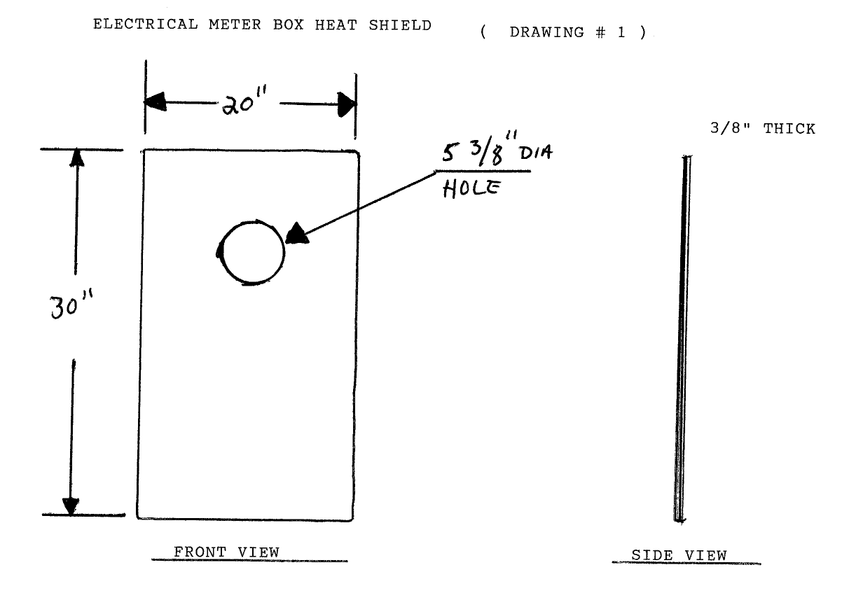

### CROSS REFERENCE TO RELATED APPLICATIONS

NOT APPLICABLE

### STATEMENT REGAURDING FEDERALLY SPONSORED RESEARCH OR DEVELOPMENT

NOT APPLICABLE.

### REFERENCE TO A MICROFICHE APPENDIX

NOT APPLICABLE.

### BACKGROUND OF THE INVENTION

The “ELECTRIC METER BOX HEAT SHIELD” Is a device devoloped to prevent the heating of electric meter boxe's and associated electrical circuit breakers from thermal energy created by the sun striking these enclosures. As an electrican for 24 years I have noticed that electrical meter boxe's that face the sun are subject to failure much more than the same enclosures whitch are not exposed to direct sun. The principal of ohms law also show's that restance in electrical circuits increases as tempture increases. The restance of electrical circuits is directly proportional to voltage and voltage drop whitch takes place when circuits are heated. There for by keeping the sun from striking electrical enclosures by installing the “ELECTRICAL METER BOX BEAT SHIELD” will provide longer service of the equiptment as well as improved current flow by reducing tempture of the equiptment whitch the “ELECTRICAL METER BOX HEAT SHIELD” is installed on.

### BRIEF SUMMARY OF THE INVENTION

The “ELECTRIC METER BOX HEAT SHIELD” is a simple shade giving device whitch slips over the meter glass on an ordinary residential electric meter. It will provide a simple easy to install means of energy savings by elinination of unwanted heat in meter box.The object is to save money on electric bill by reducing resistance and heat in the household circuits.

### BRIEF DESCRIPTION OF THE SEVERAL VIEWS OF THE INVENTION

Drawing #1 shows a one dementional view of the front of the “electrical box heat shield” having a width of 20″ and a hight of 30′ there is a round hole in the upper third of the “electrical box heat shield” it is 5⅜ in diamiter. A side view of the “electric meter box heat shield” shows a thicknes of ⅜ nominal.

### DETALED DESCRIPTION OF THE INVENTION

The “electrical meter box heat shield” is cut from the pattern described in Drawing #1 with a sissors or razor knife. It may be cut from stamping type machiens. The material used to make the “electric meter box heat shield” is styrofoam insulation board thickness of ⅜ The “electrical meter box heat shield” also may be construsted using the pattern described in Drawing #1 from any other dense matieral including card board,plastic card board,heavy gauge paste board whitch can be folded for mailing or rolled and put in to mailing tubes to facillatate distrubution by power companys or electric service providers, as deemed feasable for production. When the “electric meter box heat shield” Is aquired by the consumer the consumer will place the “electric meter box heat shield” over the meter glass to shade the underlying electrical meter box. The tight fit of the round hole in the “electric meter box heat shield” will hold the shield in place due to the taper of most all ordinary electrical watt hour meters.

I Mr. Patrick Detchman Sr. Tital: Electrican and Electrical contractor.

1. The “electric meter box heat shield”
#1 Is intended to extend the life of the electric meter box installed upon.
#2 Is intended to reduce energy consumption thru prevention of voltage drop associated with high thermal tempture of electrical apperatus, meter jaw, main breaker, branch breakers, wires, fuses, contained inside the consumer meter box when protected by “electric meter box heat shield”.
#3 Is easy to install.
#4 Is safe.
